(19) United States
(12) Patent Application Publication
(10) Pub. No.: US 2017/0036612 A1
(43) Pub. Date: Feb. 9, 2017

(54) Ladder Rack for Vehicle Trailers

(71) Applicants: Glenn R. Johnson, Beach Lake, PA (US); John Pallay, JR., Hawley, PA (US)

(72) Inventors: Glenn R. Johnson, Beach Lake, PA (US); John Pallay, JR., Hawley, PA (US)

(21) Appl. No.: 14/818,386

(22) Filed: Aug. 5, 2015

(51) Int. Cl. B60R 9/04

(52) U.S. Cl. CPC B60R 9/04

(57) ABSTRACT

A ladder rack for transporting ladders on the roof of a vehicle trailer comprising ladder support members. The ladder support members include male and female crossbars that telescope. Extending downward from the crossbar are connecting bars. T-shaped t-bar side mounting brackets are connected to the bottom of the connecting bars, which side mounting brackets are employed to connect the ladder rack of the present invention to the rain gutter of the vehicle trailer. A ladder stop may be provided which extends vertically upward from the crossbar to prevent lateral movement of a transported ladder.

### FIELD OF THE INVENTION

The present invention is a rack for placement on the roof of a vehicle trailer for holding one or more ladders. More specifically, the ladder rack of the present invention has telescoping crossbars to facilitate placement and securing on a variety of different width trailers.

### BACKGROUND OF THE INVENTION

Contractors, carpenters, plumbers and many other tradespeople need to carry ladders on their vehicles. This is typically accomplished by attaching the ladder to the roof of their vehicle, either directly or through use of a ladder rack. Most commonly, contractors attach a ladder to the roof of their enclosed vehicle trailer using a prior art ladder rack. The prior art ladder racks for installation on an enclosed trailer rack previously available were designed for use with a trailer rack of a particular width. Moreover, ladder racks designed for use with a particular width trailer do not always fit on all trailers of this particular width. This is problematic because dealers are required to stock and sell not only several different widths of ladder racks, but also multiple types of the same size ladder rack for mounting on different trailers. It would be an advantage to offer one rack that can be employed not only on different width vehicle trailers but also on trailers from multiple manufacturers. This would allow dealers to stock and sell only one ladder rack for trailers that could be used on a wide variety of different trailers. It would be advantageous to provide a ladder rack that can be adapted for use with trailers ranging in width from 4 feet to 8.5 feet. It would be advantageous to provide such a ladder rack that is easy to assemble and install in just a few minutes. Such are the objectives of the present invention.

Other objectives, advantages and novel features, and further scope of applicability of the present invention will be set forth in the detailed description to follow, taken in conjunction with the accompanying drawings, will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a ladder rack for transporting one or more ladders on the roof of a vehicle trailer. The ladder rack comprises ladder support members which include male and female crossbars that telescope relative to each other. Extending downward from the crossbar are connecting bars. T-shaped t-bar side mounting brackets are connected to the bottom of the connecting bars, which side mounting brackets are employed to connect the ladder rack of the present invention to the rain gutter of the vehicle trailer. A ladder stop may be provided which extends vertically upward from the crossbar to prevent lateral movement of a transported ladder.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a front perspective view of the ladder rack of the present invention having the male crossbar.

FIG. 1a is a rear perspective view of the ladder rack of the present invention having the male crossbar and showing the T-bar side mounting bracket attached.

FIG. 2 is a front perspective view of the ladder rack of the present invention having the female crossbar.

FIG. 2a is a rear perspective view of the ladder rack of the present invention having the female crossbar.

FIG. 3 is a partially cutaway view of the present invention ladder rack showing the male crossbar inserted into the female crossbar.

FIG. 4 shows two units of the present invention in position to be installed onto the roof of a vehicle trailer.

FIG. 5 shows two units of the present invention installed onto the roof of a vehicle trailer.

FIG. 6 is a cross-sectional view of the crossbar of the present invention taken along 6-6 on FIG. 5.

FIG. 7 shows two units of the present invention installed onto the roof of a vehicle trailer and retaining a ladder.

### DETAILED DESCRIPTION OF THE INVENTION

The present invention is a rack for placement on the roof of a vehicle trailer and is used to transport one or more ladders from one place to another. The ladder rack of the present invention includes telescoping crossbars which crossbars can be re-sized depending on the size of the roof of the trailer. More specifically, the ladder rack is designed and configured to be used on the top of any width enclosed vehicle trailer. The ladder rack of the present invention permits dealers of such racks to stock and sell one ladder rack for use on trailers that will fit a wide variety of different trailers, ranging in width from 4 feet to 8.5 feet.

The ladder rack of the present invention is used in pairs (more than two may be used for large trailers or large ladders), one for use toward the front of the roof of the vehicle trailer and one toward the rear. The front and rear units are identical. Generally, each of the ladder racks members includes a first ladder support and a second ladder support which two ladder supports telescope relative to each other. The ladder rack of the present invention is formed from corrosion resistant extruded aluminum, although ladder racks of this design formed from other metals or materials are also within the scope of this disclosure.

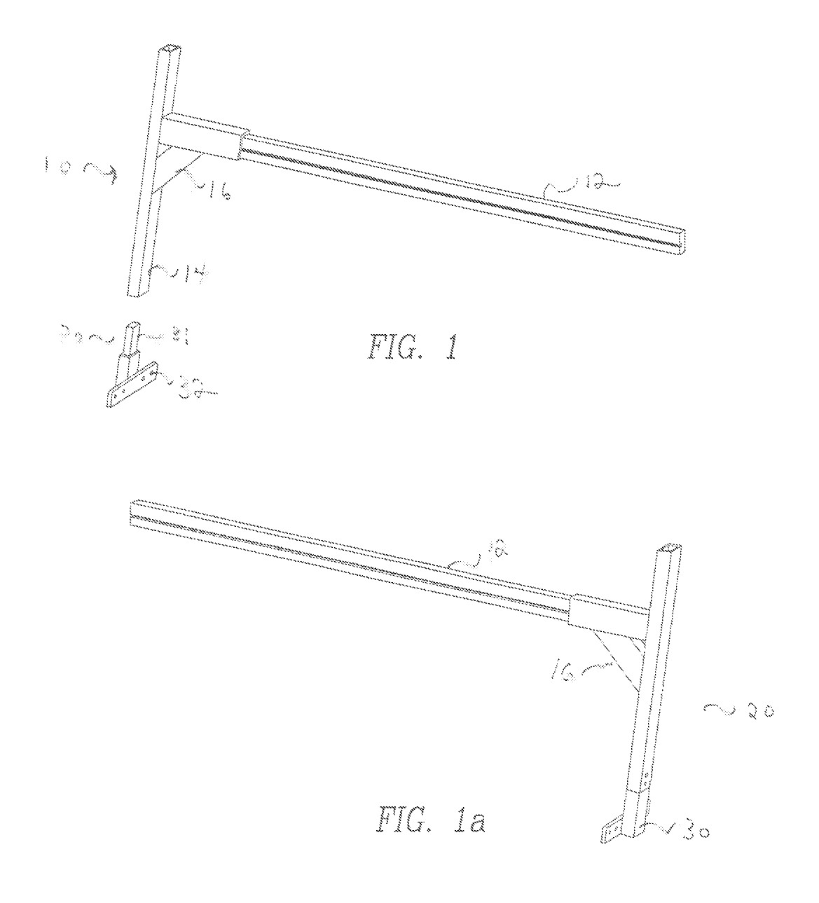

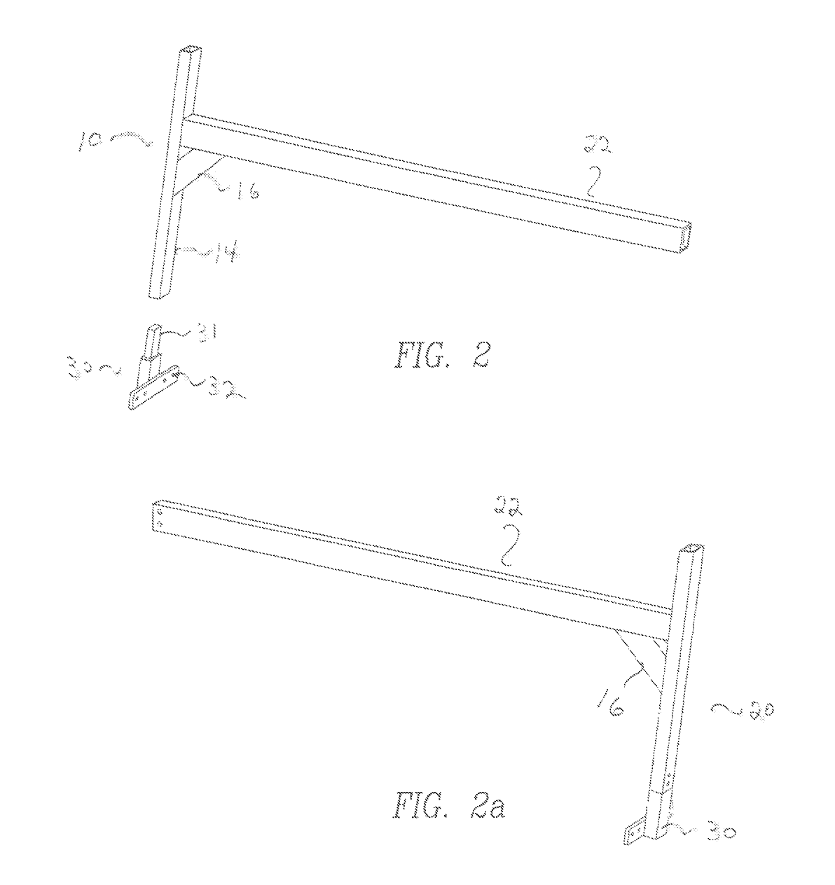

Looking at the figures, and first at FIG. 1, the first ladder support is designated generally as 10, and the second ladder support is designated generally as 20. Each of the ladder supports 10 and 20 includes a crossbar 12 and 22. The first crossbar 12 (male crossbar) is sized and configured so that it will fit inside the female crossbar 22 and they will slide in and out relative to each other. As such, the two crossbar members telescope relative to each other so that the overall length of the crossbar can be chosen according to the width of the trailer roof to which it is to be installed.

Looking more closely at the two ladder support members, each crossbar is connected to a vertical connecting rod 14, the connecting rod extending downward perpendicularly from the crossbar as well as perpendicularly upward from the crossbar as seen in the figures. The connecting rods are braced to the crossbars using braces 16.

Connected to the bottom of the connecting bars is the T-bar side mounting bracket 30 which is utilized to attach the ladder rack to the rain gutters of a trailer. The T-bar side mounting bracket is a t-shaped separate piece that attaches to the rain gutter of the trailer roof, and is attached to the ladder support members using screws. The T-bar side mounting bracket each a tab 31 which tab is inserted into the bottom of the vertical connecting rod 14. The T-bar side mounting bracket takes the shape of an inverted letter T, the horizontal portion of which includes screw holes 32 for attaching to the rain gutter of the vehicle trailer using screws. The tab of the T-bar side mounting bracket is inserted upward into the bottom of the connecting bar, and the T-bar side mounting bracket is then screwed to the connecting bar.

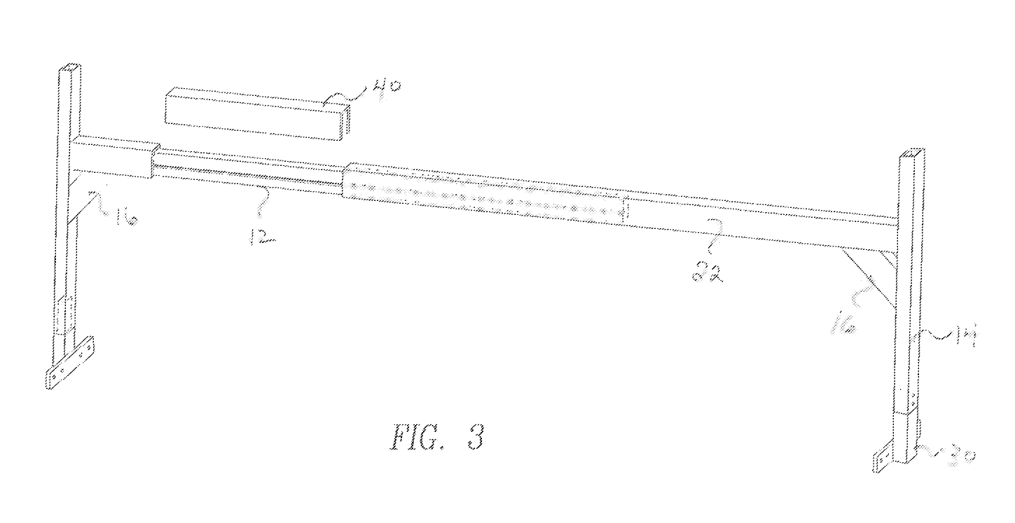

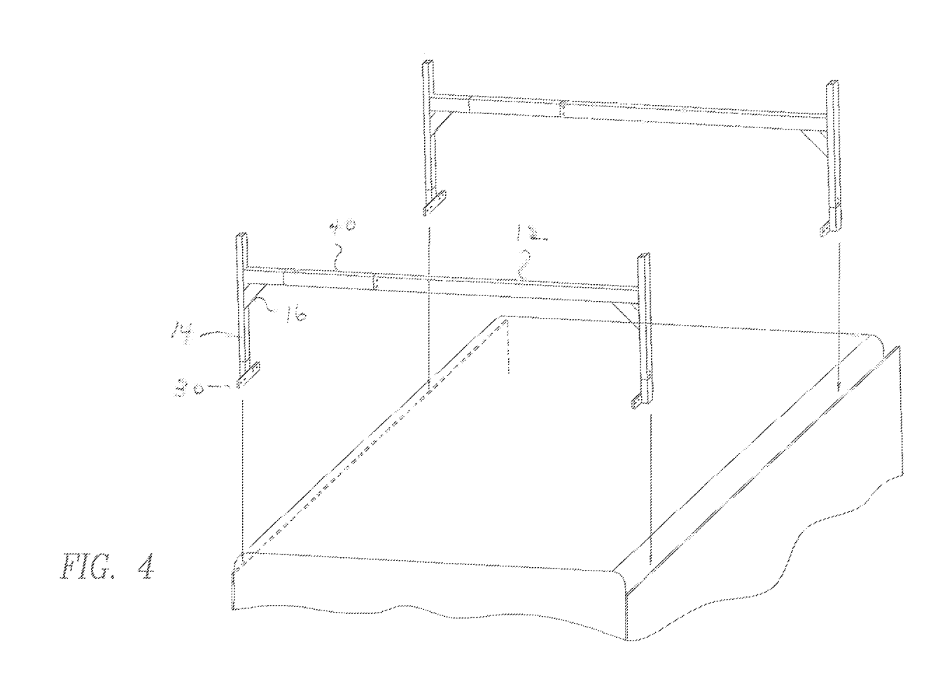

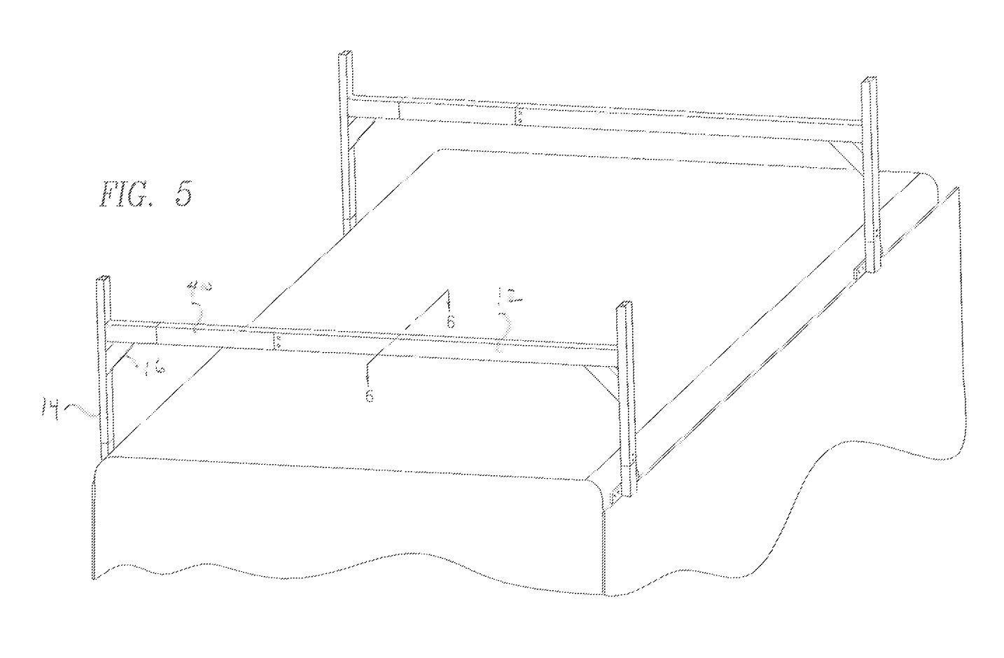

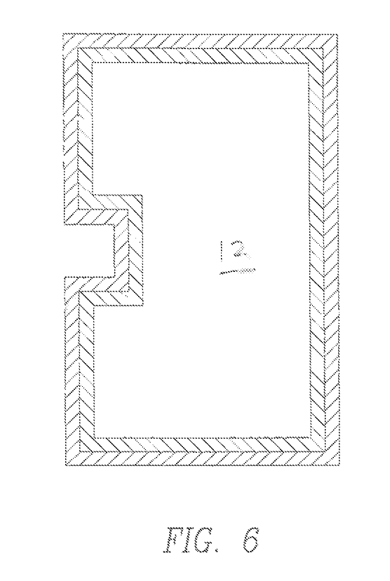

As seen best in FIG. 3, a cover 40 for the crossbar are provided. The cover covers the portion of the male crossbar that is exposed, i.e. not inserted into the female crossbar. The cover shields the crossbar from moisture and dirt, and may be cut to size.

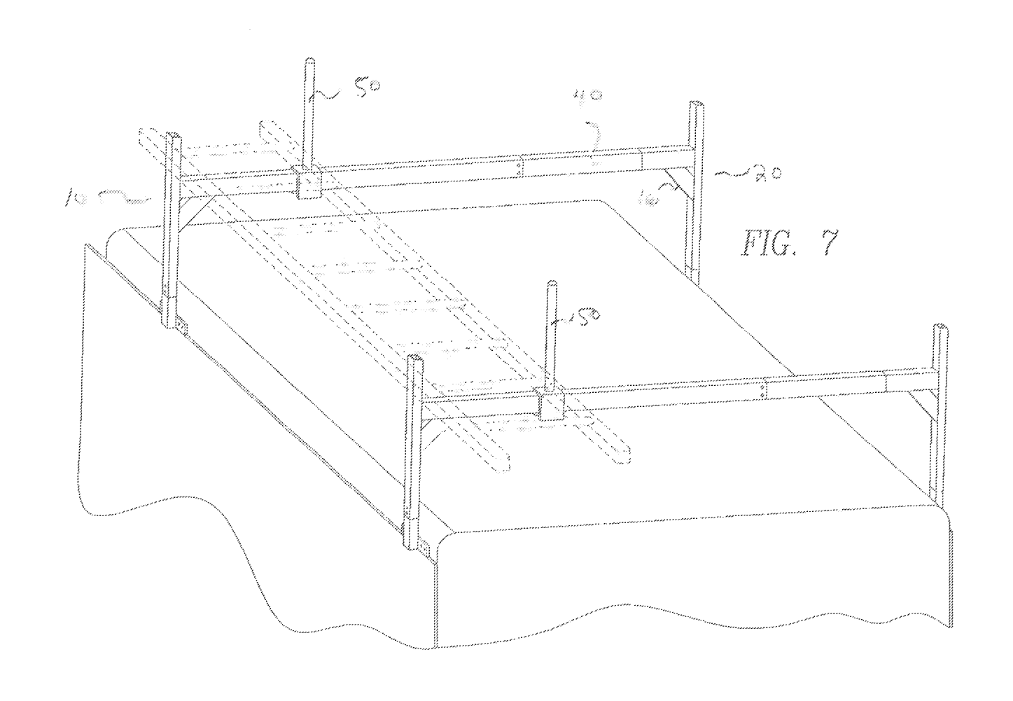

Looking at FIG. 7, a vertical ladder stop 50 may be provided that extends upward from the connecting rod. The ladder stop is utilized to prevent a ladder from shifting from side to side when the ladder is being transported.

To mount the ladder rack onto the roof of a vehicle trailer, the user takes the following steps. First a measurement of the width of the trailer is taken. The measurement must be taken horizontally and straight from rain gutter to rain gutter of the trailer and not in a curved fashion over the top of the trailer. It is noted that the present invention can be mounted to trailers that do not have rain gutters. In this situation, the measurement is taken horizontally from roof edge to roof edge. (The measurement cannot be taken over the roof of the trailer as this will result in an incorrect measurement.) Now, if the horizontal rain gutter to rain gutter width is less than five feet, the female crossbar must be cut. The t-bar side mounting brackets are inserted into the bottom of the connecting bar, and these parts are screwed together. Next, the male crossbar is inserted into the female crossbar and the two parts are telescoped relative to each other until the overall length of the two united crossbars is the same as the measured distance of the trailer from rain gutter to rain gutter. The two crossbars are attached to each other using screws. Next, the cover is cut to size, and affixed to the portion of the male crossbar that is exposed (not inserted into the female crossbar) to protect it against moisture and dirt. The cover is screwed in place to attach. Now, the entire ladder rack is installed onto the roof of the vehicle trailer. The entire ladder rack is lifted to the roof of the trailer and the t-bar mounting brackets are positioned into the rain gutters of the trailer. In the case where the trailer does not have rain gutters, the mount is simply screwed to the side of the trailer. Tapping screws are used to attach the rain gutter mounts to the rain gutter of the vehicle, thereby attaching the ladder rack to the roof of the vehicle. The process is repeated for additional ladder racks. (At least two ladder racks are needed to support the ladders.) Finally, once the ladder racks are mounted to the roof, the ladder or ladders may be placed upon them. The vertical ladder-stabilizing rod 50 extends vertically upward from the crossbar and is positioned properly according to the width of the ladder or ladders, thereby preventing the ladder from shifting side to side.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

1. A rack for transporting ladders on the roof of a vehicle, comprising:
a first ladder support, said first ladder support including a male crossbar;
a second ladder support, said second ladder support including a female crossbar;
a first connecting bar attached to and extending downward from said male crossbar, and also upward from said male crossbar, said first connecting bar having a bottom end;
a second connecting bar attached to and extending downward from said female crossbar, and also upward from said female crossbar, said second connecting bar having a bottom end;
a t-bar mounting bracket attached to said bottom end of said first connecting bar; and
a t-bar mounting bracket attached to said bottom end of said first connecting bar;
whereby said male crossbar is inserted into said female crossbar and telescopes relative thereto thereby adjusting the width of said ladder rack and allowing the ladder rack to be installed on different width vehicle trailers.

2. The rack for transporting ladders of claim 1 which further includes a ladder stop extending vertically upward from said ladder rack.

3. (canceled)
